(19) United States
(12) Patent Application Publication
(10) Pub. No.: US 2009/0192853 A1
(43) Pub. Date: Jul. 30, 2009

(54) METHOD AND APPARATUS FOR MANAGING COMMUNICATION SERVICES

(76) Inventors: Robert A. Drake, Nashville, IN (US); Gerald W. Rea, Scottsburg, IN (US); Wes G. Brandenburg, Underwood, IN (US)

Correspondence Address: BAKER & DANIELS LLP, 300 NORTH MERIDIAN STREET, SUITE 2700, INDIANAPOLIS, IN, 46204, US

(21) Appl. No.: 12/362,596

(22) Filed: Jan. 30, 2009

Related U.S. Application Data
(60) Provisional application No. 61/024,882, filed on Jan. 30, 2008.
(60) Provisional application No. 61/050,950, filed on May 6, 2008.

(51) Int. Cl. G06Q 99/00; G06Q 10/00; G06F 17/30

(52) U.S. Cl. 705/7; 705/1; 707/1; 707/104.1

(57) ABSTRACT

Online communities often do not include the same level of trust or accountability as face-to-face communities. A system is disclosed wherein a member of an online community is able to increase their contact ration. A system is disclosed wherein a member of an online community is held accountable to the actions of other community members with which the member is associated.

### CROSS REFERENCE TO RELATED APPLICATIONS

This application claims the benefit of U.S. Provisional Patent Application Ser. No. 61/024,882, filed Jan. 30, 2008, titled METHOD AND APPARATUS TO LINK MEMBERS OF A GROUP, Docket JORCH-P0001 and U.S. Provisional Patent Application Ser. No. 61/050,950, filed May 6, 2008, titled METHOD AND APPARATUS TO LINK MEMBERS OF A GROUP, Docket JORCH-P0001-05, the disclosures of which are expressly incorporated by reference herein.

### BACKGROUND AND SUMMARY

The present invention relates to systems and methods for improving interactions between members of an online community, and in particular, to improve the level of responsibility within the online community.

Communication with electronic devices has become widespread. People are sending instant text messages, e-mails, and other forms of communication electronically with a variety of devices, such as desktop computers, laptop computers, cell phones, handheld data devices, such as BLACKBERRY devices, and other computing devices.

Unlike face-to-face interactions, communication through electronic media insulates the sender from their audience. Often people participating in an online community will never meet each other in person or even know the actual identify of another person. Hence people feel free to join an online community, abuse it, and change user accounts once an account develops a bad reputation in the online community or simply leave the online community.

As such, the prevalence of unwanted use or abuse of electronic communication in online communities is a problem. For example, unsolicited electronic messages, commonly known as “spam”, are regularly sent out to a mass audience by a sender. The sender, once identified as a spammer, simply abandons the current user account and opens a new user account. The spamming starts all over again. Further, a message sent by a sender may contain objectionable content. Exemplary objectionable content includes vulgarity, pornography, or harassment. Examples of harassment include cyber-bulling.

Regarding spam, existing online communities, such as MySpace and Facebook, include policing methods wherein messages may be marked as spam. Sufficient reported spam incurs penalties for that account. A similar option, for policing the community, is available in online communities, such as eBay and other marketplaces, wherein members are able to provide feedback on the conduct of other members. Examples of feedback include the speed of a transaction, the veracity of information provided by a member, the ease of working with the member, and other aspects. However, all of these approaches are reactive, not proactive.

In face-to-face communities, the community expects for an individual to earn privileges first and then if that person abuses the privileges; the privileges are lost. In addition, in face-to-face communities individuals have a sense of community responsibility and accountability.

In an exemplary embodiment of the present disclosure, a method for managing contacts in an online community is provided.

In another exemplary embodiment of the present disclosure, a system for providing accountability in an online community including a plurality of spaced apart online community member computing devices which are connectable to a network is provided. The system comprising a computing device being operatively connected to the plurality of online community member computing devices through the network; a memory accessible by the computing device; a database stored on the memory, the database including for each online community member a ration of contacts, the database further including an indication that a first online community member is a grantor for a second online community member; and at least one community application stored on the memory. The at least one community application providing the online community members with an ability to submit a contact. The computing device receives a request from the second online member computing device over the network for a first contact, grants the request for the first contact, receives a message from a third online community member computing device over the network indicating that the first contact failed at least one community standard, and in response to the message adjusting a contact ration of the second online community member and a contact ration of the first online community member. The contact ration from the first online community member being adjusted because the first online community member is the grantor for the second online community member. In a variation thereof, the contact ration for the first online community member is reduced by a first amount and the contact ration for the second online community member is reduced by a second amount, the second amount being greater than the first amount. In another variation thereof, a contact ration for a fourth online community member is adjusted because the fourth online community member is a grantor to the first online community member. The contact ration for the fourth online community member being reduced by a third amount, the third amount being less than the first amount. In yet another variation, a contact ration for a fourth online community member is adjusted because the fourth online community member has the most interaction with the second online community member.

In a further exemplary embodiment of the present disclosure, a method of providing accountability in an online community is provided. The method comprising the steps of receiving at a computing device of the online community a message from a first member of the online community over a network, the message indicating that a contact of a second member of the online community failed a standard of the online community; automatically decreasing a contact ration of the second member of the online community stored on a computer readable medium based on the message received from the first member of the online community; and automatically decreasing a contact ration of a third member of the online community stored on a computer readable medium based on the message received from the first member of the online community and an association between the third member of the online community and the second member of the online community. In a variation thereof, the association is based on the third member of the online community being a grantor of the second member of the online community. In another variation, the association is based on a level of interaction between the third member of the online community and the second member of the online community.

In still a further exemplary embodiment of the present disclosure, a system for providing accountability in an online community including a plurality of spaced apart online community member computing devices which are connectable to a network is provided. The system comprising a computing device being operatively connected to the plurality of online community member computing devices through the network; a memory accessible by the computing device; a database stored on the memory, the database including for each online community member a ration of contacts; and at least one community application stored on the memory. The at least one community application providing the online community members with an ability to submit a contact, wherein the computing device receives a request from a first online member computing device over the network for a first contact, the computing device executes an accountability application which retrieves a contact ration from the database for the first online member and grants the request for the first contact if a contact usage from the database for the first online member is less than the contact ration from the database for the first online member. In a variation thereof, the contact is one of a message to a second online community member and a post to at one community application. In another variation, the contact is a message to a plurality of online community members. In a refinement thereof, the computing device receives a second message from a second online community member which received the message, the second message indicating that the message failed at least one community standard, the computing device determining if the first online community member should have their contact ration reduced based on the received second message from the second online community member. In a further refinement thereof, the computing device reduces the contact ration of first online community member and at least a contact ration for a third online community member. In still a further refinement thereof, the third online community member is associated with the first online community member in that the computing device had increased the contact ration of the first online community member based on a request received from the third online community member. in yet still a further refinement, the computing device reduces the contact ration of a fourth online community member due to the fourth online community member being associated with the third online community member in that the computing device had increased the contact ration of the third online community member based on a request from the fourth online community member. In another variation, the third online community member is identified by the computing system as being in a circle of accountability with the first online community member. In yet another variation, the first contact ration of the first online community member is increased by an activity level of the first online community member in the online community.

In still yet a further exemplary embodiment of the present disclosure, a method of providing accountability in an online community is provided. The method comprising the steps of receiving at a computing device of the online community a request to join the online community from a first online community member; providing the first online community member with a contact ration stored on a memory accessible by the computing device; automatically increasing the contact ration stored on the memory accessible by the computing device based on a period of time and an activity level of the first online community member in the online community; and automatically decreasing the contact ration stored on the memory accessible by the computing device based on a determination made by the computing device that a contact submitted by the first online community member failed a standard of the online community. In a variation thereof, the determination made by the computing device that the contact submitted by the first online community member failed the standard of the online community is made by: receiving messages from a plurality of other members of the online community over the network that the contact submitted by the first online community member failed the standard of the online community; for each message determining a value for the message based on a trust point amount associated with the online community member; summing the value for all of the messages; and comparing the summed value to a threshold value, the contact submitted by the first online community member failing the standard of the online community when the summed value exceeds the threshold value. In a refinement thereof, the trust points for each online community member are stored on the memory accessible by the computing device and are automatically increased based on a period of time and an activity level of the online community member in the online community and are automatically decreased based on a determination made by the computing device that a respective contact submitted by the online community member failed a standard of the online community. In another variation, the contact is a post to a community application viewable by members of the online community.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a representative view of an online community;

FIG. 2 is a representative view of a computer system associated with a member of the online community;

FIG. 3 is a representative view of the interaction of a plurality of computer systems of FIG. 2 having access to various community applications and one or more databases over a network;

FIG. 4 is a representative view of information regarding members of the online community stored in the databases of FIG. 3;

FIG. 5 is a representative view of various community applications for a first online community;

FIG. 6 is a representative view of information regarding members of the online community stored in the databases of FIG. 3;

FIG. 7 is a representative view of a processing sequence for processing a request for a new contact;

FIG. 8 is a representative view of a member's contact ration increases over time and activity;

FIG. 9 is a representative view of a member granting another member a leadership position;

FIG. 10 is a representative view of a processing sequence for increasing a Member's contact ration;

FIG. 11 is a representative view of a hierarchy of accountability between members of the online community;

FIG. 12 is a representative view of a processing sequence for decreasing a member's contact ration based on the hierarchy of accountability;

FIG. 13 is a representative view of various implementations of the accountability application, such as associated with a clearinghouse server;

FIG. 14 is a representative view of a processing sequence for permitting account creation with the use of a trust bureau; and

FIGS. 15A and 15B are representative of information stored in exemplary trust databases for the trust bureau of FIG. 14.

### DETAILED DESCRIPTION OF THE DRAWINGS

The embodiments of the invention described herein are not intended to be exhaustive or to limit the invention to the precise forms disclosed. Rather, the embodiments selected for description have been chosen to enable one skilled in the art to practice the invention.

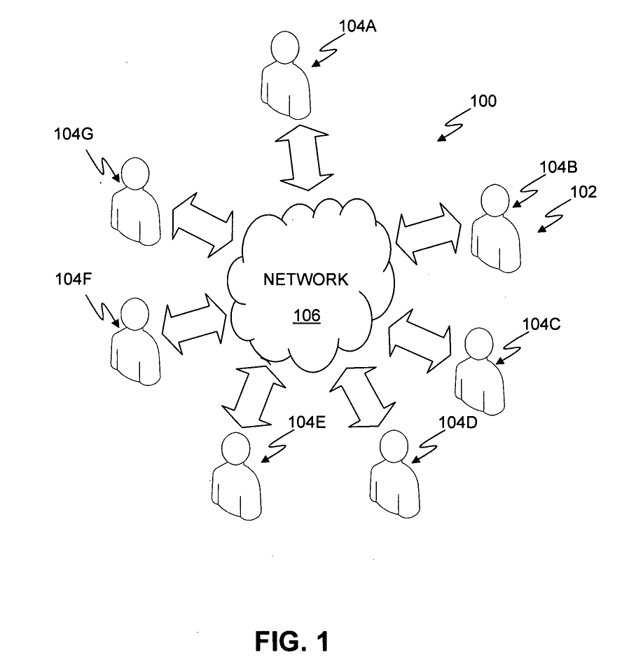

Referring to FIG. 1, an online community 100 is represented. Online community 100 is a collection of community members 102 (exemplary community members 104A-104G illustrated) which communicate through an electronic communication network 106. Electronic communication network 106 may be a collection of one or more wired or wireless networks through which a given community member 104A is able to communicate with another community member 104C.

In one embodiment, online community 100 is a closed community meaning that in order to post content or otherwise communicate with one or more of community member 102, a user must be a registered member of the online community 100. In one example, non-members of online community 100 may observe at least a portion of the content posted by online community members 102 and/or receive communications from an online community member 104. In one example, a new user must be invited to join the online community 100. In another example, a new user may freely join online community 100 by completing an account creation process, thereby becoming a registered user. Exemplary account creation processes are described in U.S. Patent Application Ser. No. ______, filed Jan. 30, 2009, titled METHOD AND APPARATUS FOR ACCOUNT MANAGEMENT, docket JORCH-P0001-02, the disclosure of which is expressly incorporated by reference herein.

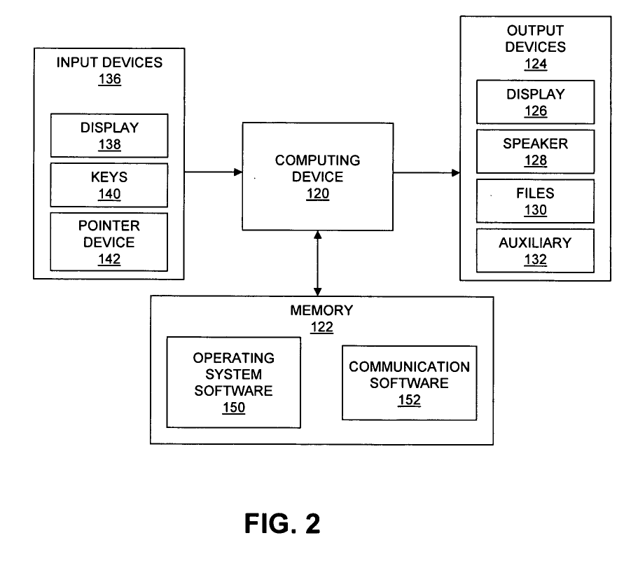

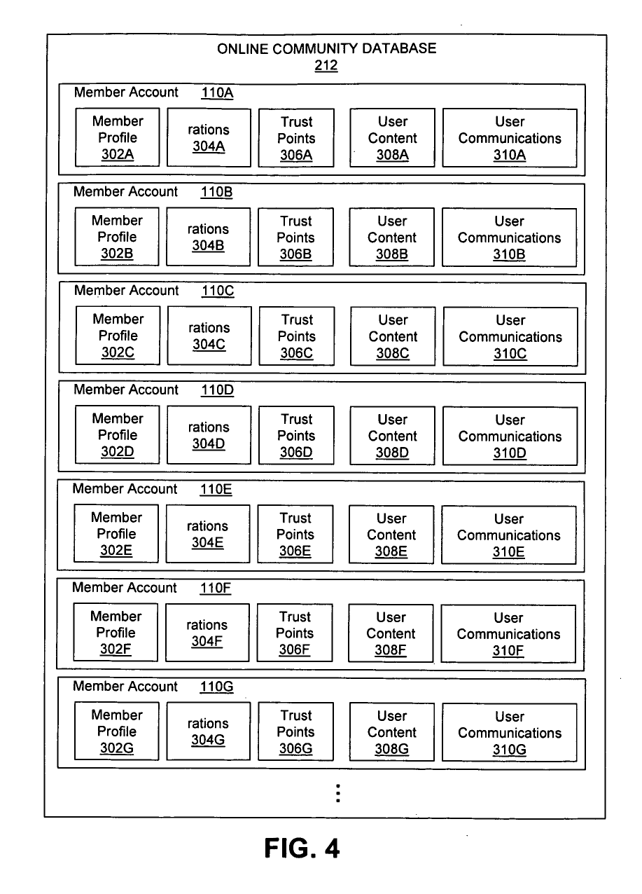

As stated above, members 102 communicate through an electronic communication network 106. Each member 102 has a member account 110 (see FIG. 4) related to online community 100. Each member 102 communicates and/or interacts as part of online community 100 through a computing device 120 (see FIG. 2). Computing device 120 may be a general purpose computer or a portable computing device. Although computing device 120 is illustrated as a single computing device, it should be understood that multiple computing devices may be used together, such as over a network or other methods of transferring data. Exemplary computing devices include desktop computers, laptop computers, personal data assistants (“PDA”), such as BLACKBERRY brand devices, cellular devices, tablet computers, or other devices capable of the communications discussed herein.

Computing device 120 has access to a memory 122. Memory 122 is a computer readable medium and may be a single storage device or multiple storage devices, located either locally with computing device 120 or accessible across a network. Computer-readable media may be any available media that can be accessed by the computing device 120 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 120.

Computing device 120 has access to one or more output devices 124. Exemplary output devices 124 include a display 126, a speaker 128, a file 130, and an auxiliary device 132. Exemplary auxiliary devices 132 include devices which may be coupled to computing device 120, such as a printer. Files 103 may have various formats. In one embodiment, files 130 are portable document format (PDF) files. In one embodiment, files 130 are formatted for display by an Internet browser, such as Internet Explorer brand browser available from Microsoft Corporation of Redmond, Wash. or the Firefox brand browser available from Mozilla Corporation of Mountain View, Calif., and may include one or more of HyperText Markup Language (“HTML”), or other formatting instructions. In one embodiment, files 130 are files stored in memory 122 for transmission to another computing device and eventual presentation by another output device or to at least to influence information provided by the another output device.

Computing device 120 further has access to one or more input devices 136. Exemplary input devices 136 include a display 138 (such as a touch display), keys 140 (such as a keypad or keyboard), a pointer device (such as a mouse, a roller ball, a stylus), and other suitable devices by which an operator may provide input to computing device 120.

Memory 122 includes an operating system software 150. An exemplary operating system software is a WINDOWS operating system available from Microsoft Corporation of Redmond, Wash. An exemplary operating system for mobile devices is the iPhone operating system available from Apple Corporation of Cupertino, Calif. Memory 122 further includes communications software 152. Exemplary communications software 152 includes e-mail software, internet browser software, and other types of software which permit computing device 120 to communicate with other computing devices across a network 106. Exemplary networks include a local area network, a cellular network, a public switched network, and other suitable networks. An exemplary public switched network is the Internet.

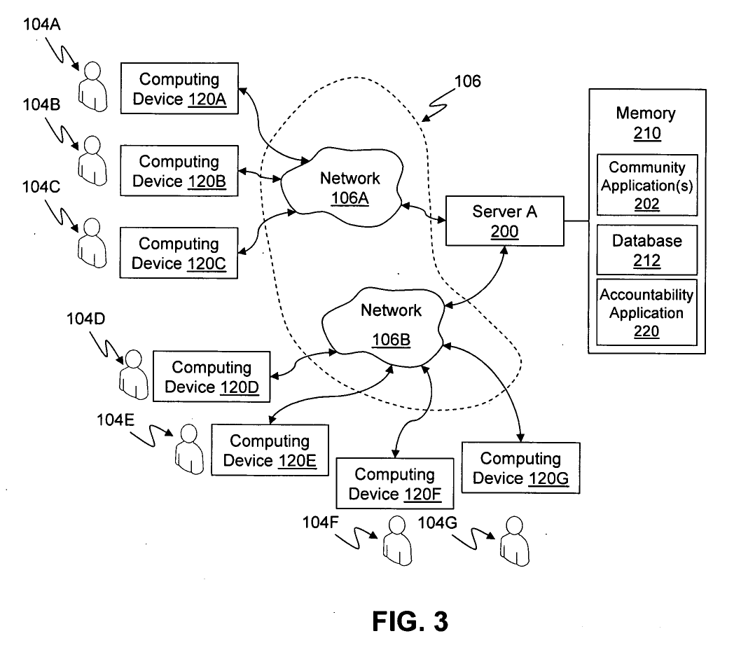

Referring to FIG. 3, each of members 104A-G of online community 100 are shown with an associated computing device 120. Of course, a given member 104 may have multiple computing devices 120 through which the member may access a computing device 200 which provides and/or manages one or more community applications 202. As illustrated, network 106 is shown including a first network 106A and a second network 106B. For example, computing devices 120A-120C may be handheld devices which communicate with computing device 200 through a cellular network 106A while computing devices 120D-120G are computers which communicate with computing device 200 through a public switched network, such as the Internet. In one example, computing devices 120A-120C also communicate with computing device 200 through the Internet, in that the provider of cellular service provides a connection to the Internet.

Computing device 200 is labelled as Server because it serves or otherwise makes available to computing devices 120A-120G various community applications 202. In one embodiment, computing device 200 is a web server and the various community applications include web sites which are served by computing device 200. Although a single server is shown, it is understood that multiple computing devices may be implemented to function as computing device 200.

Computing device 200 has access to a memory 210. Memory 210 is a computer readable medium and may be a single storage device or multiple storage devices, located either locally with computing device 200 or accessible across a network. Computer-readable media may be any available media that can be accessed by the computing device 200 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 200.

In addition to one or more community applications 202, memory 210 stores one or more databases 212 which are used by the community applications 202. In one embodiment, databases 212 are stored in a MySQL database system available from MySQL AB, a subsidiary of Sun Microsystems Inc, located in Cupertino, Calif.

Memory 210 also includes an accountability application 220. As explained herein accountability application 220 policies the number of content postings and/or communications that each member 102 is able to perform in a given time period. The content postings and communications are grouped under the meaning of contacts in this application. In one embodiment, accountability application 220 limits all types of content positing and communications for the online community 100 for each member. In another embodiment, accountability application 220 limits only certain types of content posting and communications for the online community 100 for each member. For instance, accountability application 220 in one embodiment limits only content positing to certain applications, like a community calendar, and communication, like e-mails to more than one recipient.

The types of community applications 202 depend on the type of online community. Exemplary types of online community 100 include auction sites, merchant sites, social networking sites, blogs, technical groups, professional groups, reference sites, event hosting sites, online education (e-learning) sites, online collaboration or meeting sites, news sites, and other sites wherein members are able to post content and/or exchange content. For example, at an auction site, community applications 202 include an application to list an item for auction, a posting application to provide feedback, and a message application to provide electronic messages between members and accountability application 220 may limit a number of items that may be added to an auction listing database, a number of postings that a member may make for providing feedback, and/or a number of messages that a member may send. Exemplary feedback includes posting remarks regarding an experience (such as a prior auction) with another member. In another example, at an online merchant site, accountability application 220 may limit a number of items that may be added to a product listing database and/or a number of postings that a member may make for providing feedback. Exemplary feedback includes posting remarks regarding an experience (such as a prior purchase) with another member. In a further example, at a social networking site, community applications may include a message application to provide electronic messages between members of the community and a posting application for adding material to a member page and accountability application 220 may limit a number of communications that a member may make to other members and/or the number of posting a member may make. For news and group interest sites, community applications may include a posting application whereby a member may comment on an article presented through the news site and accountability application 220 may limit the number of comments that a member may attach to articles or other content presented by the news or group interest site. In yet another example, at a reference site (such as wikipedia), community applications include a content posting application to add information to the reference article and a comment positing application whereby a member may leave peer review comments about an article and accountability application 220 may limit the number of content postings a member may make to the site and/or the number of comments that a member may attach to articles or other content presented by the reference site. In still a further example, at a career site (such as monster.com), community applications may include a job posting application and a resume submission application and accountability application 220 may limit the number of job postings or resume submissions a member may make to the site.

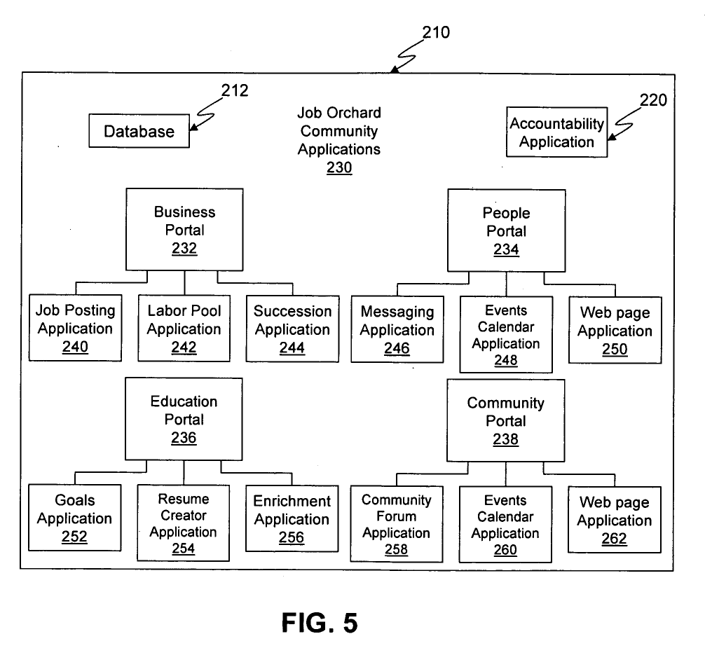

In one embodiment, accountability application 220 is used in connection with the community applications 230 shown in FIG. 5. Community applications 230 correspond to the online community described in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein. The online community has four portals: a business portal 232, a people portal 234, an education portal 236, and a community portal 238. Portals 232, 234, 236, and 238 are provided by computing device 200 and are accessible by an end user over one or more networks 106 by local computing devices 120.

Business portal 232 provides information, advertisements, and/or web pages for the businesses in a real world community which are stored in databases 212. Exemplary real world communities include neighborhoods, towns, cities, townships, counties, regions, and other geographical boundaries. Business portal provides access to multiple community business applications which are described in more detail in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A first exemplary community business application is a job posting application 240. The job posting application 240 provides an employer with the ability to create an employment listing for members of the community to view and, if desired, apply for consideration. Additional details regarding job posting application 240 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A second exemplary community business application is labor pool evaluation application 242. The labor pool evaluation application 242 permits a business to search the active labor pool to determine to search for community members that satisfy various criteria. The business owner may then contact the community members to gauge their interest in an employment or other opportunity. In one embodiment, the labor pool evaluation application 242 permits a business to search a reserve labor pool to determine the ability to have community members to relocate to a specific region if an opportunity existed. Additional details regarding a reserve workforce application is described in U.S. patent application Ser. No. 12/195,913, filed Aug. 21, 2008, titled METHOD AND APPARATUS FOR WORKFORCE ASSESSMENT, docket JORCH-P0001-01, the disclosure of which is expressly incorporated by reference herein.

A third exemplary community business application is a business succession application 244. The business succession application 244 permits a business to plan for a future retirement or departure of a business owner or leader. Additional details regarding business succession application 244 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

People portal 234 provides a social networking site which includes information stored in databases 212. People portal 234 provides access to multiple community people applications which are described in more detail in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A first exemplary community people application is a messaging application 246. The messaging application 246 provides a member the ability to communicate with other members. Exemplary messaging applications include e-mail messaging and text messaging. Additional details regarding messaging application 246 are provided in U.S. Patent Application Ser. No. (unknown), filed Jan. 30, 2009, titled METHOD AND APPARATUS TO LINK MEMBERS OF A GROUP, docket JORCH-P000-04, the disclosure of which is expressly incorporated by reference herein.

A second exemplary community people application is an events calendar application 248. The events calendar application 248 provides an interactive calendar for the community, portions of the community such as a group, and the individual member. The member is able to post both private calendar events, invitation only events which are reviewable by the intended recipient, and public events. Additional details regarding events calendar application 248 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein..

A third exemplary community people application is a web page application 250. The web page application 250 provides the member with the ability to post information about themselves, images, audio, and video on a web page viewable by the community. In one embodiment, web page application 250 prevents the web page from being viewed by the whole community if the member's age is under 18. Additional details regarding web page application 250 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

Education portal 236 provides a learning environment for members of the online community and includes information stored in databases 212. Education portal 236 provides access to multiple community education applications which are described in more detail in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A first exemplary community education application is a goals application 252. The goals application 252 provides an interactive survey and a pictorial representation of a member's goals. The goals application also provides a roadmap to assist the member in reaching those goals. Additional details regarding goals application 252 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A second exemplary community education application is a resume creator application 254. The resume creator application 254 provides a step-by-step interview which results in a prepared resume. Additional details regarding resume creator application 254 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A third exemplary community education application is an enrichment application 256. The enrichment application 256 provides potential educational opportunities to the member. Additional details regarding enrichment application 256 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

Community portal 238 provides information related to the community and includes information which is stored in databases 212. Community portal 238 provides access to multiple community applications which are described in more detail in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A first exemplary community application is a community forum application 258. The community forum application 258 provides a place for members of the community to post ideas for consideration by others. Additional details regarding community forum application 258 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A second exemplary community application is an events calendar application 260. The events calendar application 260 provides a place for community groups to post information about upcoming events in the real world community associated with the online community. Additional details regarding events calendar application 260 are provided in U.S. patent application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

A third exemplary community application is a web page application 262. The web page application 262 provides community organizations with the ability to post information about themselves, images, audio, and video on a web page viewable by the community. Additional details regarding web page application 262 are provided in U.S. Patent Application Ser. No. (unknown), filed Jan. 30, 2009, titled METHOD AND APPARATUS TO LINK MEMBERS OF A GROUP, docket JORCH-P0001-04, the disclosure of which is expressly incorporated by reference herein.

Returning to FIG. 4, an exemplary representation of database 212 is shown. Database 212 includes a plurality of member accounts 110A-G which correspond to members 104A-G. Although seven accounts and members are used for illustration, it is contemplated that much larger populations may be members of the online community.

Each member account 110 has associated information which is referred to as a user profile 302. Exemplary information that may be included in user profile 302 includes, name, id name in community, password, address, phone number, e-mail address, age, gender, credit card information, and other types of information.

Further each member account 110 has associated ration information 304. Ration information includes a number of contacts that the member is permitted to make through the online community 100. As described herein, each member has a specified number of contacts they are able to make through the community. In one embodiment, at least a portion of the members are able to have unlimited contacts.

Each member account 110 may also have associated trust information 306. Exemplary trust information 306 includes a quantity of trust points that the member 104 has acquired through good community behavior, reward, or additional suitable methods. As described herein, trust points may change a level of influence of a member 104 in the online community 100. In one embodiment, having a larger number of trust points increase the level of influence of the member in the online community 100.

Each member account 110 may also have associated member content information 308. Exemplary member content information includes any content that the member has or plans to post through a community application. For example, the member has a webpage which is hosted by computing device 200. The member would provide content to include on that webpage to a webpage application. In another example, the member may have an item to sell through an auction site. The member would then add the item to the auction site through an auction item listing application. In yet another example, the member may have a comment to post to a news article. The member would then associate the comment with the news article through a comment application.

Each member account 110 may also have associated member communications information 310. Exemplary member communications information includes any communications that the member has sent or received through the online community. Exemplary communications include voice messages, e-mail messages, text messages, and other types of communications that the member may send or receive through the online community. communications information may also include data mined from content external to the community. One method for mining such data is semantic web analysis.

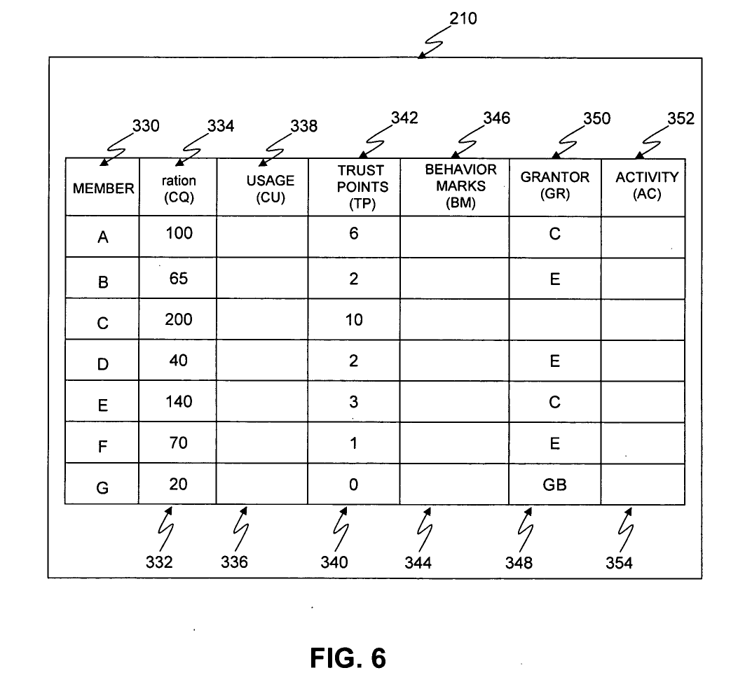

Referring to FIG. 6, a representation of a portion of databases 212 used by accountability application 220 is shown. Each member 104 is identified and has an associated contact ration value 332 of a contact ration variable 334, an associated contact usage value 336 of a contact usage variable 338, an associated trust points value 340 of a trust points variable 342, a behavior marks value 344 of a behavior marks variable 346, and a grantor value 348 of a grantor variable 350.

In one embodiment, a new member 104 to the online community must be invited to join the online community 100 or attain certain privileges or roles within the community. In this scenario, each member has an associated grantor identified in FIG. 6.

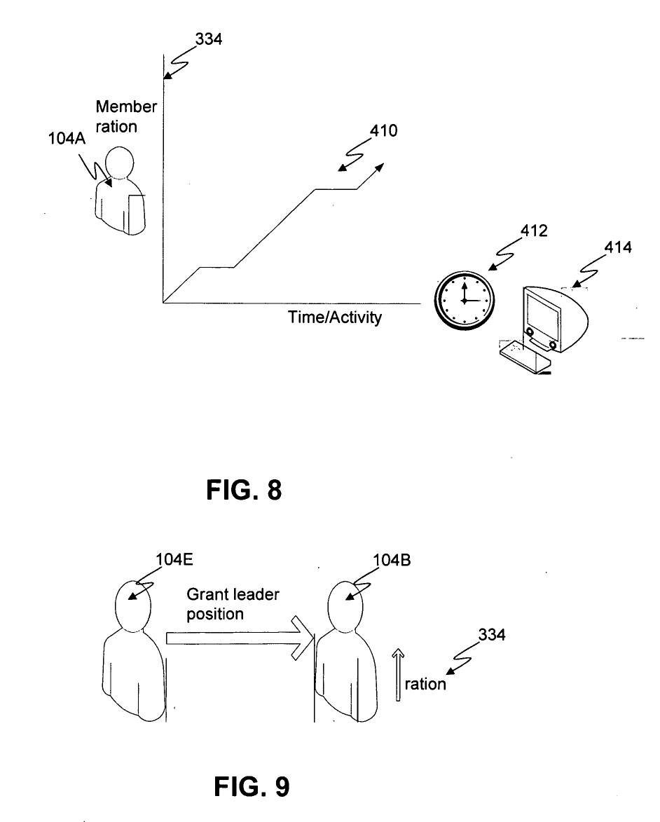

In one embodiment, a new member 104 to the online community may freely join the online community 100. The member registers with the online community 100 and is given a first ration level for contacts. Referring to FIGS. 8 and 9 two methods of increasing the ration level for a given member 104 are explained.

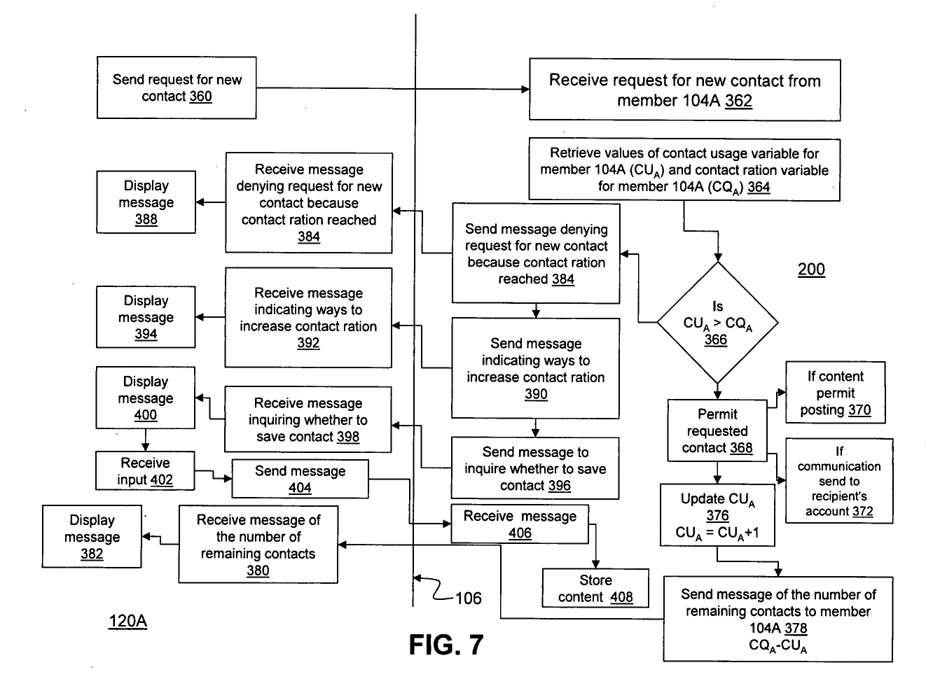

Referring to FIG. 7, a first processing sequence of accountability application 220 is shown. A member 104A through computing device 120A sends a request for a new contact to computing device 200, as represented by block 360. In one embodiment, the request corresponding to selecting a send input on an e-mail or an add content input on a news site. Computing device 200 receives the request through network 106, as represented by block 362. accountability application 220 retrieves the values of contact ration variable 334 (CQ_{A}) and contact usage variable 338 (CU_{A}) for member 104A, as represented by block 364. accountability application 220 then determines whether the request for new contact should be granted or denied, as represented by block 366. In one embodiment, accountability application 220 compares the value of contact usage variable 338 (CU_{A}) for member 104A to the value of contact ration variable 334 (CQ_{A}) for member 104A and permits the request for new contact unless the value of contact usage variable 338 (CU_{A}) for member 104A exceeds the value of contact ration variable 334 (CQ_{A}) for member 104A.

Assuming the value of contact usage variable 338 (CU_{A}) for member 104A does not exceed the value of contact ration variable 334 (CQ_{A}) for member 104A accountability application 220 grants the request for the new contact, as represented by block 368. If the request is for posting new content, then the content is allowed to be posted, as represented by block 370. If the request is for sending a communication, the communication is sent to the account of the recipient, as represented by block 372. User 104A receives a notification that the request for new contact has been granted, as represented by block 374. In one embodiment, the notification is that the requested action is allowed (the communication is sent or the content is posted).

Accountability application 220 also updates the value of contact usage variable 338 (CU_{A}) for member 104A, as represented by block 376. In one embodiment, the value of contact usage variable 338 (CU_{A}) for member 104A is incremented by one. In one embodiment, each type of new contact has the same effect on the value of contact usage variable 338 (CU_{A}) for member 104A. In one embodiment, different types of contact have different effects on the value of contact usage variable 338 (CU_{A}) for member 104A. For example, in one embodiment wherein the new contact is a communication the value of contact usage variable 338 (CU_{A}) for member 104A is incremented by one for each receipt of the communication. In a similar manner, posting content may have different effects on the value of contact usage variable 338 (CU_{A}) for member 104A depending on the type of content to be posted and/or the site to which the content is to be posted. For example, it may have less of an effect for a member to post content to their own web page with a web page application then to post content to a community event board with a calendar application.

Accountability application 220, in one embodiment, sends a message to computing device 120A through network 106 which includes the number of new contacts member 104A has left, as represented by block 378. Computing device 120A receives the message which includes the number of new contacts left, as represented by block 380. Based on the received message, computing device 120A displays a message on display 126 which indicates the number of new contacts left, as represented by block 382.

Assuming the value of contact usage variable 338 (CU_{A}) for member 104A does exceed the value of contact ration variable 334 (CQ_{A}) for member 104A accountability application 220 denies the request for the new contact and sends a message to computing device 120A through network 106 which informs member 104A that their contact usage has exceeded their content ration, as represented by block 384. Computing device 120A receives the message which informs member 104A that their contact usage has exceeded their content ration, as represented by block 386. Based on the received message, computing device 120A displays a message on display 126 which informs member 104A that their contact usage has exceeded their content ration, as represented by block 388.

In one embodiment, accountability application 220 sends a message to computing device 120A through network 106 which informs member 104A ways in which they may increase their contact ration and/or when their contact usage will be reset, as represented by block 390. Computing device 120A receives the message which informs member 104A ways in which they may increase their contact ration and/or when their contact usage will be reset, as represented by block 392. Based on the received message, computing device 120A displays a message on display 126 which informs member 104A ways in which they may increase their contact ration and/or when their contact usage will be reset, as represented by block 394.

In one embodiment, accountability application 220 sends a message to computing device 120A through network 106 which inquires whether member 104A wants to save the content of the new contact, as represented by block 396. Computing device 120A receives the message which inquires whether member 104A wants to save the content of the new contact, as represented by block 398. Based on the received message, computing device 120A displays a message on display 126 which inquires whether member 104A wants to save the content of the new contact, as represented by block 400. In one embodiment, the displayed message includes an input requesting the content be saved and an input requesting the content be discarded. Computing device 120A receives a selection of either an input requesting the content be saved and an input requesting the content be discarded, as represented by block 402. Computing device 120A then sends a message to computing device 200 through network 106 which indicates the selection of either the input requesting the content be saved or the input requesting the content be discarded, as represented by block 404. Computing device 200 receives the message which indicates the selection of either the input requesting the content be saved or the input requesting the content be discarded, as represented by block 406. Accountability application 220 then either saves the content to memory 210 or discards the content, as represented by block 408. In one embodiment, the contents of the new contact may be tagged so that the saved message is automatically sent when enough contact points become available. In one example, member 104A selects a tag option on the displayed message inquiring whether to save or discard the contents of the contact. In one example, selecting to save the contact automatically tags the contact to be sent when enough contact points become available.

Referring to FIG. 8, the value of contact ration variable 334 (CQ_{A}) for member 104A is increased (as represented by graph 410) over time due to one or both of the passage of time 412 and activity within the community 414. In one embodiment, the value of contact ration variable 334 (CQ_{A}) for member 104A is increased every predefined time period. In one example, the predefined time period is a month. In one embodiment, the activity within the community 414 is related to the number of new contacts the member used in the prior time period. In one embodiment, the activity is related to the completion of various programs of the online community. For example, a member may earn a higher ration by completing various surveys posted by other community members, completing training programs, and performing other types of community service.

Referring to FIG. 9, another processing sequence of accountability application 220 is shown. For each member, the values of contact ration variable 334 (CQ), trust points variable 342 (TP), and an activity variable 352 (AC) are retrieved along with a time from a clock of computing device 200, as represented by block 420. As mentioned herein, activity may be simply equal to the value of contact usage variable 338 (CU), may be related to types of community service performed, or may be a sum of the value of contact usage variable 338 (CU) and the credit for the various types of community service performed. The values are reviewed by accountability application 220 which determines if enough time and/or activity has passed to increase the value of contact ration variable 334 (CQ) and trust points variable 342 (TP), as represented by block 422. In one embodiment, this determination is made by granting the user x trust points and y ration for two weeks of time with good behavior plus b trust points and c ration for completing a county survey. Further, in one embodiment, accountability application 220 may decrease a member's ration and/or trust points due to inactivity. In one embodiment, the member may decrease the functionality the user is allowed. For example, a user may lose or be limited in the ability to post a picture to a personal web page.

Assuming that the value of contact ration variable 334 (CQ) and trust points variable 342 (TP) are to be increased or decreased, an adjustment amount for each is determined, as represented by block 424. In one embodiment, this determination is made by the severity of the incident breaching the community trust. The new values for contact ration variable 334 (CQ) and trust points variable 342 (TP) are stored in memory 210, as represented by block 426. Accountability application 220 also sends messages to each member 104 through network 106 notifying them that their rations and trust points have been adjusted, as represented by block 428. These messages are received by the respective computing device 120 for each member 104, as represented by block 430, and to display the message on display 126, as represented by block 432.

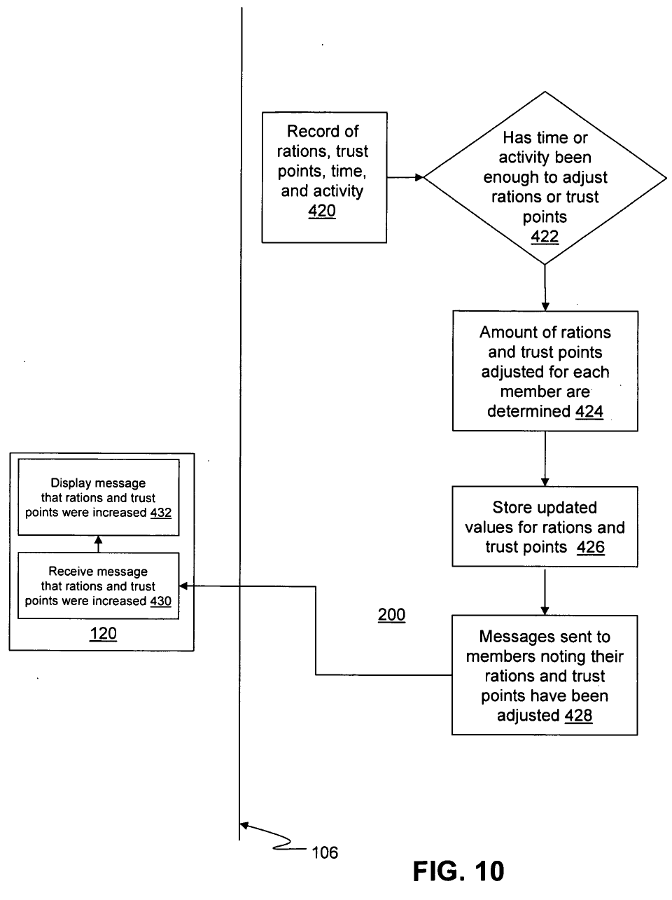

One type of community activity 414 that results in increasing a member's values for contact ration variable 334 (CQ) and trust points variable 342 (TP) is when the member is given a position of responsibility in the community, as represented by FIG. 10. As shown in FIG. 10, member 104E has granted member 104B a position of responsibility in the community. Exemplary positions of responsibility are leadership positions within a club or organization, such as president, vice-president, treasurer, secretary, committee chairperson, and others. When member 104E grants member 104B the position of responsibility in the community, member 104E is signaling to the remainder of the community that member 104E trusts member 104B. Referring to FIG. 6, this connection is noted as member 104E is now listed as a grantor for member 104B.

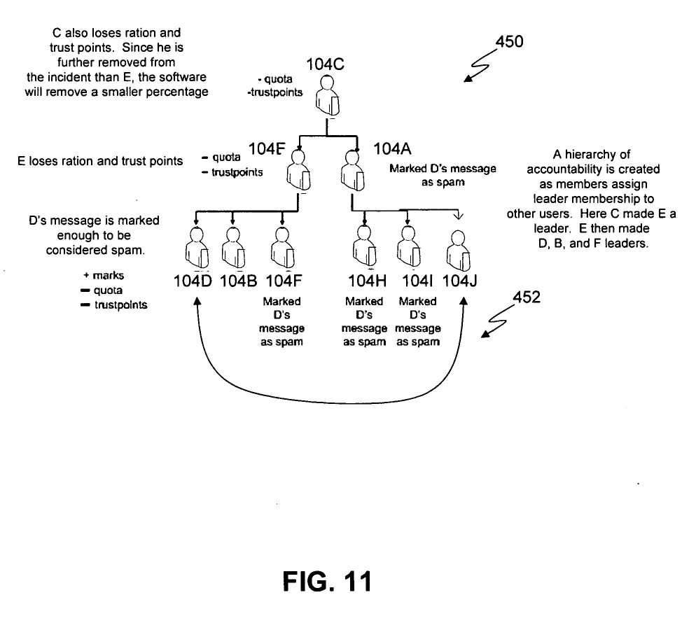

Referring to FIG. 11, a hierarchy of accountability 450 of member 104 of community 100 is shown. As shown in FIG. 11, member 104C is considered a grantor for members 104E and 104A. In the case of FIG. 11, member 104C has assigned leadership positions to each of members 104A and 104E. In another embodiment, member 104C may have simply invited members 104A and 104E to join community 100. As also shown in FIG. 11, member 104B is considered a grantor for members 104B, 104D, and 104F and member 104A is considered a grantor for members 104H and 104I.

The hierarchy of accountability 450 shown in FIG. 11 fosters accountability between members 104 of community 100. As explained herein, when a given member 104 of community 100 acts in an unwanted manner (as indicated by the value of their behavior marks variable 346), not only is that member 104 reprimanded, but also those members 104 which are considered grantors to that member. One example is explained in FIG. 11. Member 104D sends a communication to each of members 104A-104C and 104E-104I. Members 104A, 104F, 104H, and 104I each consider the communication to be spam and report it as such. Based on the members reporting the communication as spam, a threshold value is reached resulting in member 104D having both the value of contact ration variable 334 and the value of trust points variable 342 reduced. The value of contact ration variable 334 and the value of trust points variable 342 are also reduced for both member 104E and member 104C. Member 104E because he was considered a grantor to member 104D. Member 104C because he was considered a grantor to member 104E. This type of hierarchical reduction makes members 104 think whether they have developed a relationship of trust with a member before they become a grantor for that member.

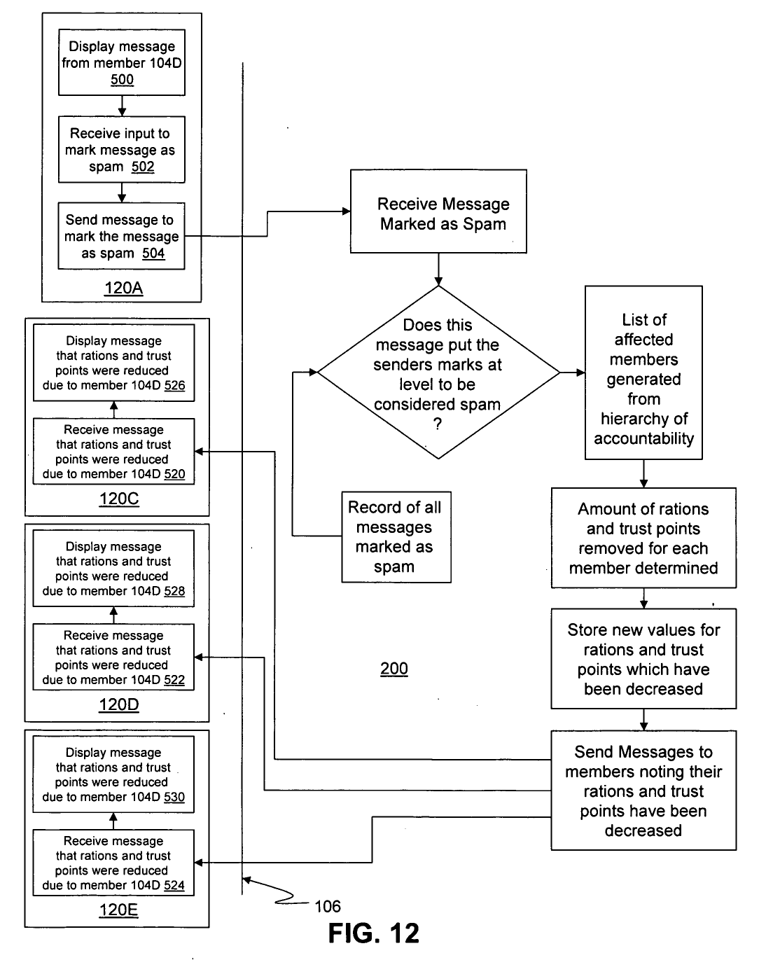

Referring to FIG. 12, another processing sequence of accountability application 220 is shown. The processing sequence is explained in connection with the example illustrated in FIG. 11. Member 104A has received the communication from member 104D. The communication is displayed on display 126 by computing device 120A, as represented by block 500. Member 104A selects an input displayed on display 126 to mark the communication as spam, as represented by block 502. Computing device 120A sends a message to accountability application 220 of computing device 200 through network 106 that member 104A feels that the communication from member 104D is spam, as represented by block 504.

Accountability application 220 receives the message from computing device 120A that the communication from member 104D was marked as spam by member 104A, as represented by block 506. For member 104D, the value of behavior marks variable 346 (BM) is retrieved, as represented by block 508. The value is reviewed by accountability application 220 which determines if the fact that member 104A marked the communication as spam is enough to put member 104D message over a threshold amount to be considered spam, as represented by block 510. In one embodiment, the value of trust points variable 342 (TP) for member 104A acts as a multiplier for member 104A in that it increases the effect of the communication being marked as spam by member 104A. In one example, the value of trust points variable 342 (TP) is a parameter in a linear relationship which determines the effect of member 104A marking the message as spam. In one example, the value of trust points variable 342 (TP) is a parameter in a non-linear relationship which determines the effect of member 104A marking the message as spam. The fact that member 104A has a lot of trust points indicates that member 104A is a trustworthy member.

In one embodiment, behavior marks 346 for member 104D are segregated on a message by message basis. In this scenario, each message is evaluated independent of other messages sent by member 104D. In one example, the threshold value is a raw number of times a message is marked regardless of the number of recipients. In one example, the threshold value is a percentage of the number times a message is marked relative to the number of recipients of the message.

In one embodiment, behavior marks 346 for member 104D are considered as a cumulative value over all messages sent. In this scenario, the number of marks are evaluated across the total messages sent by member 104D. In one example, the threshold value is a raw number of times any message is marked regardless of the number of recipients or number of messages. In one example, the threshold value is a percentage of the number times any message is marked relative to a sum of the number of recipients of each message. In one example, the threshold value is a raw number of times any message is marked regardless of the number of recipients or number of messages. In one example, the threshold value is a percentage of the number times any message is marked relative to the ration of member 104A.

Assuming that the fact that member 104A marked the message as spam does not result in member 104D going over the threshold for spam, the points associated with member 104A marking are simply added to the total for (BM) for member 104D. Assuming that the fact that member 104A marked the message as spam results in member 104D going over the threshold for spam, a list of affected members is generated from hierarchy of accountability 450, as represented by block 512. Those members which are grantors to member 104D, either directly or indirectly, are determined.

An adjustment amount in the value of contact ration variable 334 (CQ) and trust points variable 342 (TP) for each of the affected members is determined, as represented by block 514. In one embodiment, this determination is made based on the percentage or raw number of the member's pre-existing trust points. In one embodiment, this determination is made based on the percentage or raw number of the member's pre-existing trust points and the level of remoteness that the member is from member 104D. In one embodiment, this determination is made based on the percentage or raw number of the member's pre-existing trust points, the level of remoteness that the member is from member 104D, and the number of recent spam occurrences by members within the member's grantee network. In one embodiment, this determination is made based on the level of remoteness that the member is from member 104D and the number of recent spam occurrences by members within the member's grantee network. In one embodiment, this determination is made based on the level of remoteness that the member is from member 104D. In one embodiment, this determination is made based on the number of recent spam occurrences by members within the member's grantee network. The new values for contact ration variable 334 (CQ) and trust points variable 342 (TP) are stored in memory 210, as represented by block 516. Accountability application 220 also sends messages to the affected members, 104C, 104D, and 104E, through network 106 notifying them that their rations and trust points have been decreased, as represented by block 518. These messages are received by the respective computing devices 120 for each of member 104C, 104D, and 104E, as represented by blocks 520, 522, and 524, respectively. The respective computing devices 120 for each of member 104C, 104D, and 104E displays the message on display 126, as represented by block 526, 528, and 530. Messages may be displayed as the adjustment occurs or as a summary on a given schedule.

In one embodiment, the adjustment amount is more for member 104D than for members 104E and 104C. Further, the adjustment amount is more for member 104E than 104C because 104E was a direct grantor of member 104D. In addition, members 104D, 104E, and 104C are also hampered in how fast they are able to regain their contact rations. In one example they are not eligible for increases for a present amount of time and/or activity. In another example, they are eligible for increases as normal, except that their rate of increase is less than before. Again, members 104D, 104E, and 104C may be treated differently.

In one embodiment, accountability application 220 permits a grantor to revoke their grant to a grantee. This will limit the grantor's exposure to future behavior problems with the grantee. It also would result in the grantee having a reduction in their contact ration. In one embodiment, accountability application 220 does not permit a grantor to revoke their grant to a grantee. This increases the accountability that each member would have to ensure that members they are grantors for are not likely to exhibit unwanted behavior.

In one embodiment, another group which is considered for decreases in ration and/or trust points is the member's peer group. This is referred to as a circle of accountability 452. In FIG. 11, member 104D and member 104J communicate often. As such, member 104J likely has an established relationship with member 104D. Member 104J may appreciate that member 104D is sending spam messages or engaging in other unwanted behavior, but does not report member 104D. In this scenario, member 104J is not acting as a responsible member of the online community. Therefore, even though member 104I is not a grantor to member 104D, member 104J's ration and/or trust points are reduced due to the frequent interaction that member 104I had with member 104D. In one example, the amount of interaction is based on the number of messages sent between member 104D and 104I. In one embodiment, member 104I has the highest amount of interaction with member 104D. If member 104I was also a grantor for member 104D, then member 104I may end up with a double reduction in ration and/or trust points.

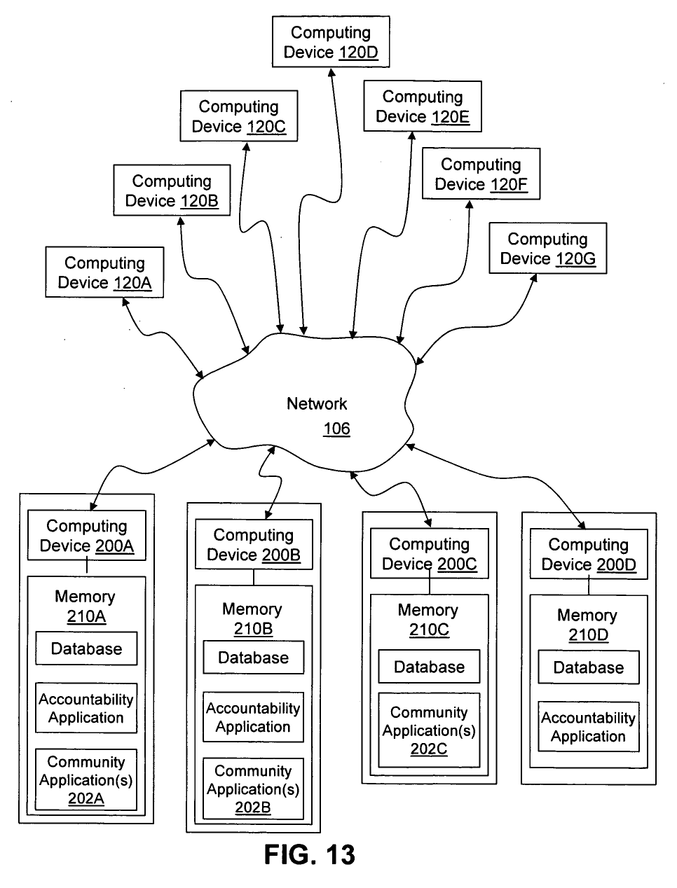

Referring to FIG. 13, computing devices 120A-120G are connected to computing devices 200A-200D through network 106. Computing device 200A corresponds to a first online community 100A having community applications 202A. Computing device 200B corresponds to a second online community 100B having community applications 202B. Computing device 200C corresponds to a third online community 100C having community applications 202C. Computing device 200A and computing device 200B each include their own copy of accountability application 220 and are independent of each other. Computing device 200C does not include its own copy of accountability application 220. Rather, computing device 200C communicates with computing device 200D through network 106 which has a copy of accountability application 220. Computing device 200D may act as a clearinghouse for multiple online communities in that it is able to manage the rations and trust points for each member of a community. This can be accomplished on a community independent basis or in the aggregate for all communities that a member is associated with and which computing device 200D manages.

Computing device 200D may also serve a trust bureau. As a trust bureau, computing device provides an indication to an online community how the member or potential member in question as behaved in other online communities. The online community may then use this information to decide whether to allow a prospective member to join the online community and/or at what level of access, whether to allow an existing member additional functionality.

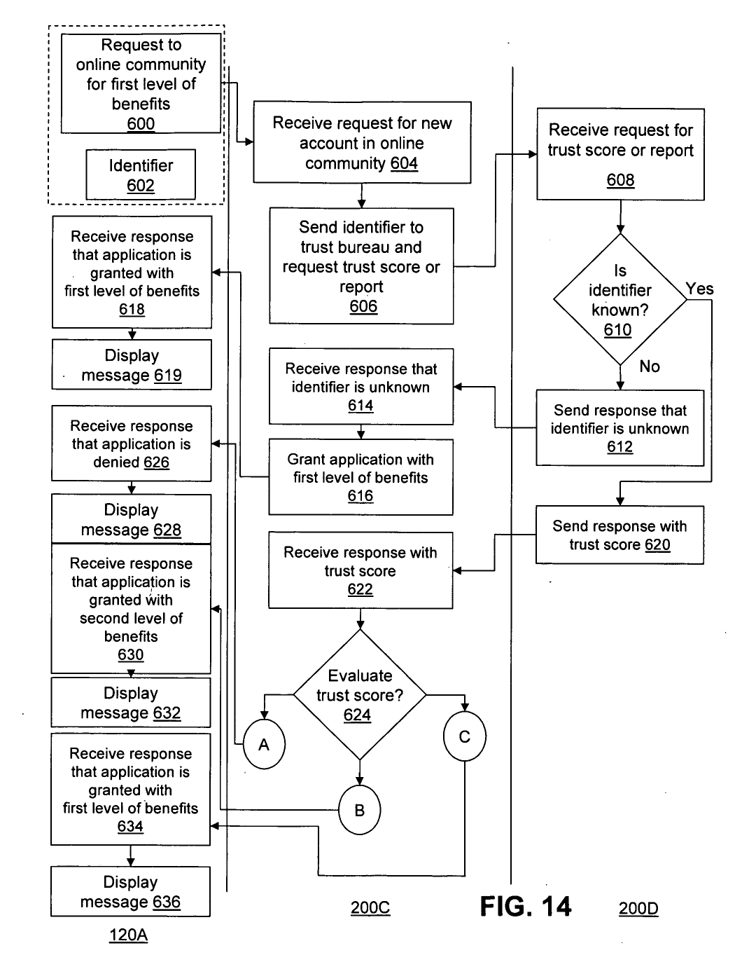

Referring to FIG. 14, a user of computing device 120A sends a request to apply to an online community, as represented by block 600. The request may also be a request for access to additional functionality within the online community for an existing account. In one embodiment, the request is a form filled out by the user with computing device 120A. An exemplary form is a web page having various inputs for user information which is provided by the online community to which the user is applying (the online community being represented by computing device 200C). At least a portion of the information provided to computing device 120A by the user is an identifier. Exemplary identifiers include a social security number, a driver license number, a passport number, or other suitable identification information. In one example, the user has a trust ID which is provided by computing device 200D.

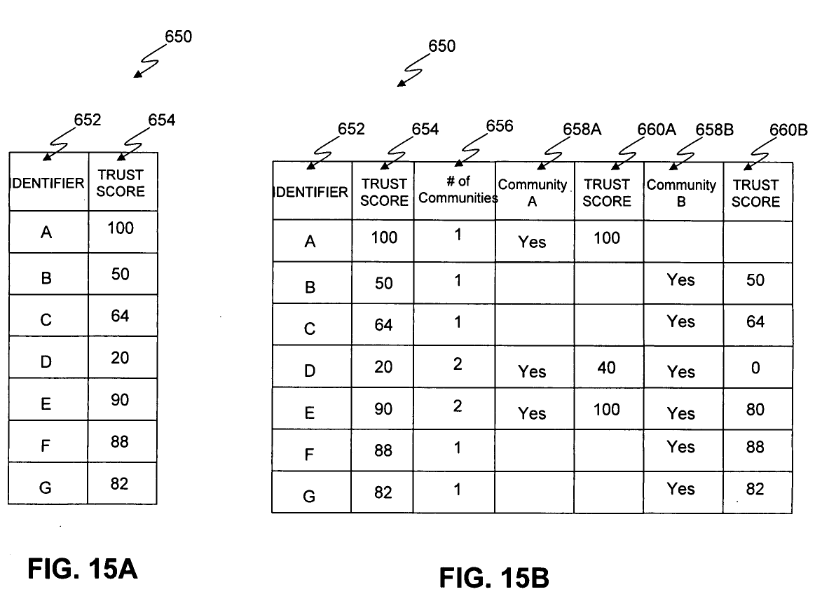

The computing device 200C of the online community receives the application from computing device 120A over network 106, as represented by block 604. Computing device 200C sends the identifier and a request for a trust score to computing device 200D which includes the accountability application 220, as represented by block 606. The trust bureau, computing device 200D, receives the request, as represented by block 608. Computing device 200D checks the received identifier against a trust database of known identifiers, as represented by block 610. Referring to FIG. 15A, the trust database 650 includes at least a plurality of identifiers 652 and an associated trust score 654 for each identifier. Referring to FIG. 15B, in one example, the trust database 650, includes a plurality of identifiers 652, a trust score 654 for each identifier, a number of reporting communities 656, the name of each reporting community 658, and the associated credit score 660. In one example, the trust score is an average of the individual trust scores for each community. In one example, the trust score is weighted based on the community, the user's history with the community, and other factors.

If the identifier is not in the trust database 650 accessible by computing device 200D, then computing device 200D sends a message back to computing device 200C that the identifier is not known by the trust bureau, as represented by block 612. The message that the identifier is not known by the trust bureau is received by computing device 200C, as represented by block 614. In the illustrated embodiment, computing device 200C grants the application to the online community, as represented by block 616. The new member is given a restricted level of functionality in the online community initially. Over time, as explained herein, the user may gain additional rations or privileges and trust points or the user may erode the level of rations or privileges they have been granted, as explained herein. A message is sent to the user of computing device 120C that their application has been granted with a first level of benefits, as represented by block 618. This message is displayed by display 126, as represented by block 619. In one embodiment, computing device 200C denies the application and instructs the potential member to first register with the trust bureau. The trust bureau may then set an initial trust score for the user based on other information, such as credit score.

If the identifier is in the trust database 650 accessible by computing device 200D, then computing device 200D sends a message back to computing device 200C including the trust score associated with the identifier, as represented by block 620. Computing device 200C receives the message, as represented by block 622. Computing device 200C evaluates the trust score, as represented by block 624. In one embodiment, computing device decides between three options based at least in part on the value of the trust score: deny request (option A); grant request with more limited parameters than requested (option B); and grant the request (option C). If the request is denied, computing device 120A receives a message to that effect from computing device 200C, as represented by block 626, and the message is displayed to the user, as represented by block 628. If the request is granted with more limited benefits or parameters then requested, computing device 120A receives a message to that effect from computing device 200C, as represented by block 630, and the message is displayed to the user, as represented by block 632. If the request is granted, computing device 120A receives a message to that effect from computing device 200C, as represented by block 634, and the message is displayed to the user, as represented by block 636.

In one embodiment, computing device 200C includes an accountability application 220 and provides an update to computing device 200D periodically regarding the trust points of each member. In one embodiment, computing device 200D acts as a clearinghouse for computing device 200C as explained herein.

Throughout this application information is sent between at least two computing devices. It is understood, that the sending computing device has a copy of the message stored in a memory accessible by the sending computing device and that the receiving computing device also has a copy of the message stored in a memory accessible by the receiving computing device. It is not required that a complete copy be stored before portions are sent, nor is it a requirement that a complete copy be received before the information therein may be used.

Although the invention has been described in detail with reference to certain preferred embodiments, variations and modifications exist within the spirit and scope of the invention as described and defined in the following claims.

1. A system for providing accountability in an online community including a plurality of spaced apart online community member computing devices which are connectable to a network, the system comprising:
a computing device being operatively connected to the plurality of online community member computing devices through the network;
a memory accessible by the computing device;
a database stored on the memory, the database including for each online community member a ration of contacts, the database further including an indication that a first online community member is a grantor for a second online community member; and
at least one community application stored on the memory, the at least one community application providing the online community members with an ability to submit a contact, wherein the computing device receives a request from the second online member computing device over the network for a first contact, granting the request for the first contact, receiving a message from a third online community member computing device over the network indicating that the first contact failed at least one community standard, and in response to the message adjusting a contact ration of the second online community member and a contact ration of the first online community member, the contact ration from the first online community member being adjusted because the first online community member is the grantor for the second online community member.

2. The system of claim 1, wherein the contact ration for the first online community member is reduced by a first amount and the contact ration for the second online community member is reduced by a second amount, the second amount being greater than the first amount.

3. The system of claim 1, wherein a contact ration for a fourth online community member is adjusted because the fourth online community member is a grantor to the first online community member, the contact ration for the fourth online community member being reduced by a third amount, the third amount being less than the first amount.

4. The system of claim 1, wherein a contact ration for a fourth online community member is adjusted because the fourth online community member has the most interaction with the second online community member.

5. A method of providing accountability in an online community, the method comprising the steps of:
receiving at a computing device of the online community a message from a first member of the online community over a network, the message indicating that a contact of a second member of the online community failed a standard of the online community;
automatically decreasing a contact ration of the second member of the online community stored on a computer readable medium based on the message received from the first member of the online community; and
automatically decreasing a contact ration of a third member of the online community stored on a computer readable medium based on the message received from the first member of the online community and an association between the third member of the online community and the second member of the online community.

6. The method of claim 5, wherein the association is based on the third member of the online community being a grantor of the second member of the online community.

7. The method of claim 5, wherein the association is based on a level of interaction between the third member of the online community and the second member of the online community.

8. A system for providing accountability in an online community including a plurality of spaced apart online community member computing devices which are connectable to a network, the system comprising:
a computing device being operatively connected to the plurality of online community member computing devices through the network;
a memory accessible by the computing device;
a database stored on the memory, the database including for each online community member a ration of contacts; and
at least one community application stored on the memory, the at least one community application providing the online community members with an ability to submit a contact, wherein the computing device receives a request from a first online member computing device over the network for a first contact, the computing device executes an accountability application which retrieves a contact ration from the database for the first online member and grants the request for the first contact if a contact usage from the database for the first online member is less than the contact ration from the database for the first online member.

9. The system of claim 8, wherein the contact is one of a message to a second online community member and a post to at one community application.

10. The system of claim 8, wherein the contact is a message to a plurality of online community members.

11. The system of claim 10, wherein the computing device receives a second message from a second online community member which received the message, the second message indicating that the message failed at least one community standard, the computing device determining if the first online community member should have their contact ration reduced based on the received second message from the second online community member.

12. The system of claim 11, wherein the computing device reduces the contact ration of first online community member and at least a contact ration for a third online community member.

13. The system of claim 12, wherein the third online community member is associated with the first online community member in that the computing device had increased the contact ration of the first online community member based on a request received from the third online community member.

14. The system of claim 13, wherein the computing device reduces the contact ration of a fourth online community member due to the fourth online community member being associated with the third online community member in that the computing device had increased the contact ration of the third online community member based on a request from the fourth online community member.

15. The system of claim 12, wherein the third online community member is identified by the computing system as being in a circle of accountability with the first online community member.

16. The system of claim 8, wherein the first contact ration of the first online community member is increased by an activity level of the first online community member in the online community.

17. A method of providing accountability in an online community, the method comprising the steps of:
receiving at a computing device of the online community a request to join the online community from a first online community member; providing the first online community member with a contact ration stored on a memory accessible by the computing device;
automatically increasing the contact ration stored on the memory accessible by the computing device based on a period of time and an activity level of the first online community member in the online community; and
automatically decreasing the contact ration stored on the memory accessible by the computing device based on a determination made by the computing device that a contact submitted by the first online community member failed a standard of the online community.

18. The method of claim 17, wherein the determination made by the computing device that the contact submitted by the first online community member failed the standard of the online community is made by:
receiving messages from a plurality of other members of the online community over the network that the contact submitted by the first online community member failed the standard of the online community;
for each message determining a value for the message based on a trust point amount associated with the online community member;
summing the value for all of the messages; and
comparing the summed value to a threshold value, the contact submitted by the first online community member failing the standard of the online community when the summed value exceeds the threshold value.

19. The method of claim 18, wherein the trust points for each online community member are stored on the memory accessible by the computing device and are automatically increased based on a period of time and an activity level of the online community member in the online community and are automatically decreased based on a determination made by the computing device that a respective contact submitted by the online community member failed a standard of the online community.

20. The method of claim 17, wherein the contact is a post to a community application viewable by members of the online community.
